(19) United States
(12) Patent Application Publication
(10) Pub. No.: US 2026/0279329 A1
(43) Pub. Date: Sep. 17, 2026

(54) Machine Learning Based Robust Voice Communication Via Head-Worn Device

(71) Applicant: Google LLC, Mountain View, CA (US)

(72) Inventors: Jamie Alexander Zyskowski, Everett, WA (US); Thomás William Inskip, VI, Seattle, WA (US); Naomi Nicole De Ocampo, Kirkland, WA (US); Seyed Farbod Taghizadeh Motlagh, Seattle, WA (US)

(21) Appl. No.: 19/480,258

(22) PCT Filed: May 9, 2023
(86) PCT No.: PCT/US2023/021595

§ 371 Date: Oct. 30, 2025

(51) Int. Cl. G10L 13/02; G02B 27/01; G06N 20/00; G10L 21/0208

(52) U.S. Cl. CPC G10L 13/02; G02B 27/017; G06N 20/00; G10L 21/0208; G02B 2027/0178

(57) ABSTRACT

A method includes receiving, from a microphone, an audio signal that represents vibrations of an ambient medium induced by (i) an utterance of a user and (ii) ambient noise. The method also includes receiving, from a vibration sensor in contact with a head of the user, an inertial signal that represents vibrations of the head induced by the utterance. The method additionally includes obtaining a voice embedding that represents a voice of the user. The method further includes generating, by a machine learning model and based on (i) the audio signal, (ii) the inertial signal, and (iii) the voice embedding, a synthesized waveform that represents the utterance in the voice of the user and independently of the ambient noise. The method yet further includes outputting the synthesized waveform.

### BACKGROUND

Two or more communication devices may be configured to transmit voice communications between one another. When a first communication device is located in an environment that includes noise, the noise may interfere with utterances of a first user of the first computing device. As a result, it may be difficult for a second user of a second device to hear and/or understand the utterances of the first user, thereby hindering the voice communication. Accordingly, it may be desirable to reduce an extent of the noise that is audible to the second user and/or improve a clarity with which the utterances of the first user are audible to the second user.

### SUMMARY

A waveform synthesis model may be configured to generate a denoised version of an audio signal that represents an utterance of a user and ambient noise. Specifically, the waveform synthesis model may be configured to generate a synthesized waveform based on the audio signal, an inertial signal, and a voice embedding. The audio signal may be captured by a microphone configured to measure vibrations of an ambient medium, and may thus represent the utterance and the ambient noise. The inertial signal may be captured by a vibration sensor (e.g., a bone conduction sensor) configured to measure vibrations of the user's head, and may thus represent the utterance but not the ambient noise. The voice embedding may provide a numerical representation of aural properties of the user's voice, thus allowing the waveform synthesis model to generate synthesized waveforms that sound like the user.

In a first example embodiment, a method may include receiving, from a microphone, an audio signal that represents vibrations of an ambient medium induced by (i) an utterance of a user and (ii) ambient noise. The method may also include receiving, from a vibration sensor in contact with a head of the user, an inertial signal that represents vibrations of the head induced by the utterance. The method may additionally include obtaining a voice embedding that represents a voice of the user. The method may further include generating, by a machine learning (ML) model and based on (i) the audio signal, (ii) the inertial signal, and (iii) the voice embedding, a synthesized waveform that represents the utterance in the voice of the user and independently of the ambient noise. The method may yet further include outputting the synthesized waveform.

In a second example embodiment, a system may include a processor and a non-transitory computer-readable medium having stored thereon instructions that, when executed by the processor, cause the processor to perform operations in accordance with the first example embodiment.

In a third example embodiment, a non-transitory computer-readable medium may have stored thereon instructions that, when executed by a computing device, cause the computing device to perform operations in accordance with the first example embodiment.

In a fourth example embodiment, a system may include various means for carrying out each of the operations of the first example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a head-mountable device, in accordance with examples described herein.

FIG. 2 illustrates a computing system, in accordance with examples described herein.

FIG. 3 illustrates a waveform synthesis system, in accordance with examples described herein.

FIG. 4 illustrates aspects of a waveform model, in accordance with examples described herein.

FIG. 5 illustrates a training system, in accordance with examples described herein.

FIG. 6 illustrates a flow chart, in accordance with examples described herein.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example,” “exemplary,” and/or “illustrative” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order. Unless otherwise noted, figures are not drawn to scale.

### I. Overview

A first communication device, which may be associated with a first user, may be configured to communicate with a second communication device, which may be associated with a second user. The communication devices may include, for example, computing devices configured to communicate over a network. When the first user uses the first computing device in a noisy environment, a microphone of the first communication device may measure both the first user's speech and ambient noise, and thus the second user may have a hard time hearing and/or understanding what the first user is trying to say. For example, it may be difficult and/or impractical to carry out a voice communication from a factory floor, a concert, a construction site, a party, and/or settings where other people are talking in proximity to the first communication device, among other noisy settings.

Some existing audio signal denoising approaches may be useful for removing noise that has properties that are constant over time (e.g., the steady hum of an HVAC system), and is thus predictable. Such audio signal denoising approaches may be inapplicable to noise that has properties that vary over time (e.g., noise with changing amplitude and/or frequency composition), and is thus not predictable. Other existing audio denoising approaches may rely on multiple microphones and/or cameras, and/or may be computationally costly to execute. Such audio denoising approaches may introduce artifacts that make voices sound distorted, and/or might not be usable with communication devices that lack the sensors and/or computing capabilities necessitated by these approaches. Accordingly, provided herein is a waveform synthesis system that addresses at least some of these drawbacks of existing audio signal processing approaches.

The waveform synthesis system may include a head-mountable device (HMD), a voice embedding model, and a waveform synthesis model. The HMD (e.g., headphones, glasses, headset, etc.) may include a microphone and a vibration sensor. The microphone may be configured to measure vibrations of an ambient medium (e.g., the air surrounding the user) induced by utterances (e.g., speech) generated by the user. The ambient medium may also include ambient noise which, in some cases, could be loud enough to significantly interfere with the user's ability to carry out a voice communication via the HMD. Thus, the microphone may be configured to generate an audio signal that represents utterances of the user and ambient noise.

The vibration sensor may be configured to measure vibrations of at least part of the user's head induced by the utterances generated by the user. For example, the vibration sensor may include a bone conduction sensor. The vibration sensor may be configured to measure vibrations of a solid medium (e.g., parts of the head), and might thus be substantially unaffected by vibrations of the ambient medium. Thus, the vibration sensor may be configured to generate an inertial signal that represents the utterances of the user but does not represent the ambient noise.

The voice embedding model may be configured to generate a voice embedding of the user's voice based on a calibration audio signal that represents calibration utterances generated by the user. For example, the calibration utterances may include one or more words or phrases that showcase a range of the user's voice. The voice embedding may be a tensor that provides a numerical representation of the user's voice. The calibration audio signal may be captured in a substantially noise-free environment (e.g., an environment where the magnitude of any noise is no more than a threshold fraction of a magnitude of the calibration utterances), and the voice embedding vector may thus be representative of the user's voice without noise interference.

The waveform synthesis model may be configured to generate a synthesized waveform that represents the user's utterances independently of the ambient noise. Specifically, the waveform synthesis model may be configured to generate the synthesized waveform based on the audio signal, the inertial signal, and the voice embedding. Since the inertial signal does not represent the ambient noise, the inertial signal may allow the waveform synthesis model to determine what aspects of the audio signal likely represent the utterances and what aspects of the audio signal likely represent the ambient noise. The voice embedding may allow the waveform synthesis model to generate synthesized waveforms that sound like the user, such that the synthesized waveform substantially corresponds to the audio signal with the ambient noise component removed therefrom.

The waveform synthesis model may be configured to generate the synthesized waveform without dependence on non-numerical intermediate representations of the utterances. For example, the waveform synthesis model might not depend on generation of textual representations of the utterances, and subsequent use of the textual representations for text-to-speech synthesis. Instead, the waveform synthesis model may be configured to map waveforms representing the audio and inertial signals to the synthesized waveform, and may thus be configured to preserve a prosody of the utterances. Thus, the synthesized waveform may sound more natural than waveforms synthesized from intermediate textual representations.

The waveform synthesis model may be trained using training samples that represent a plurality of different types of noise and/or utterances by a plurality of different training users. For example, for each ground-truth audio signal generated by a particular training user of the plurality of different training users, a plurality of different types of ambient noise may be added, thus allowing the waveform synthesis model to learn how to synthesize each training user's voice under different ambient noise conditions. Thus, the waveform synthesis model may be trained to remove both constant and time varying ambient noise.

In some cases, the waveform synthesis model may be trained to process audio and inertial signals generated by, respectively, a microphone and vibration sensor placed at specific poses (i.e., positions and orientations) with respect to the user's head (e.g., due to a specific HMD form factor and/or HMD model). Different sensor pose-specific instances of the waveform synthesis model may be trained to account for how the relationship between signal and noise varies across different sensor placements, thus allowing for generation of higher quality synthesized waveforms. Thus, the waveform synthesis system may be configured to select, from a plurality of pose-specific instances of the waveform synthesis model, a waveform synthesis model that corresponds to the poses of the microphone and inertial sensor used to generate the audio signal and the inertial signal, respectively.

### II. Example Head-Mountable Device

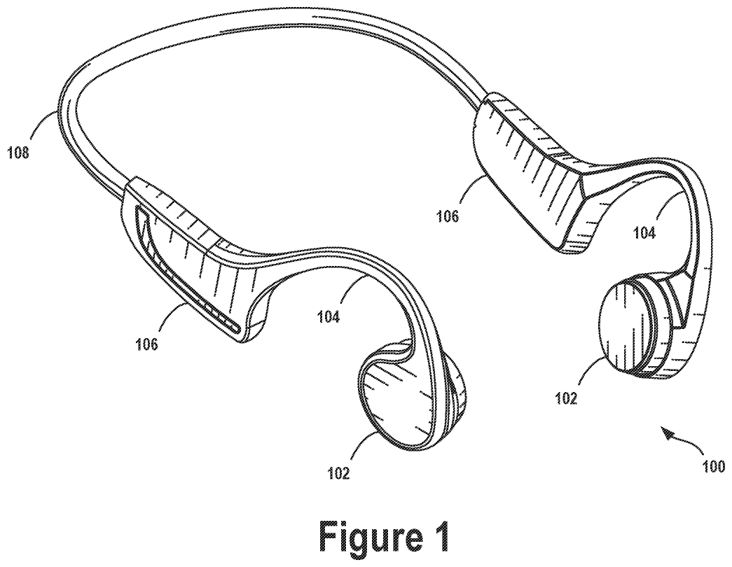

A communication and/or computing device/system may take the form of and/or may include a head-mountable device (HMD). An HMD may generally be any device that is capable of being worn on the head of a user. The HMD may take various forms such as a helmet, headset, headphones, earphones, and/or eyeglasses. FIG. 1 illustrates HMD 100 in the form factor of a headset. HMD 100 and/or variations thereof may be used as part of voice communications, virtual reality (VR) applications, augmented reality (AR) applications, and/or gaming applications, among other possibilities.

HMD 100 may include frame elements, including ear bands 104 and neckband 108. Ear bands 104 and neckband 108 may be configured to secure HMD 100 to a user's head via the user's ears and neck, respectively. Additionally or alternatively, HMD 100 may connect to or be affixed within a head-mountable helmet and/or headset structure. Ear bands 104, neckband 108, and/or other components of HMD 100 may be adjustable to allow the fit of HMD 100 to be adjusted for different users. In some implementations, ear bands 104 and/or neckband 108 may be replaced, modified, and/or omitted to create a different form factor of HMD 100.

HMD 100 may additionally include component housing 102 and component housing 106, one or more of which may include an on-board computing system (not shown). The on-board computing system may include, for example, a processor and memory. HMD 100 may include one or more finger-operable touch pads and one or more buttons (not shown) for controlling aspects of HMD 100. Component housings 102 and/or 106 may also include other electrical components, and/or may be electrically connected to electrical components at other locations within and/or on HMD 100.

HMD 100 may include multiple sensors and/or output devices, which may be housed within component housings 102 and/or 106. For example, HMD 100 may include one or more gyroscopes, one or more accelerometers, one or more magnetometers, one or more light sensors, one or more infrared sensors, one or more microphones, and/or one or more vibration sensors (e.g., bone conduction sensors), one or more speakers for generating audio output. The speaker could be in the form of an audio speaker and/or a bone conduction speaker (e.g., a bone conduction transducer (BCT)).

### III. Example Computing System

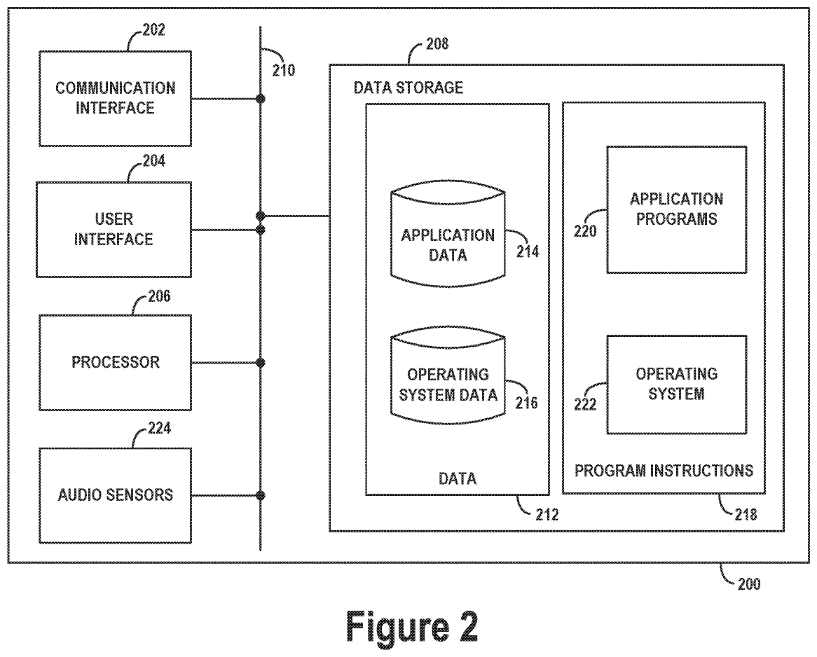

FIG. 2 is a simplified block diagram showing some of the components of an example computing system 200, which may be used as a communication device. By way of example and without limitation, computing system 200 may be a cellular mobile telephone (e.g., a smartphone), a computer (such as a desktop, notebook, tablet, server, or handheld computer), a home automation component, a digital video recorder (DVR), a digital television, a remote control, a wearable computing device (e.g., an HMD), a gaming console, a robotic device, a vehicle, or some other type of device. Computing system 200 may represent, for example, aspects of HMD 100.

As shown in FIG. 2, computing system 200 may include communication interface 202, user interface 204, processor 206, data storage 208, and audio sensors 224, all of which may be communicatively linked together by a system bus, network, or other connection mechanism 210. Computing system 200 may be equipped with at least some audio capture and/or audio processing capabilities. It should be understood that computing system 200 may represent a physical audio processing system, a particular physical hardware platform on which an audio sensing and/or processing application operates in software, or other combinations of hardware and software that are configured to carry out audio capture and/or processing functions.

Communication interface 202 may allow computing system 200 to communicate, using analog or digital modulation, with other devices, access networks, and/or transport networks. Thus, communication interface 202 may facilitate circuit-switched and/or packet-switched communication, such as plain old telephone service (POTS) communication and/or Internet protocol (IP) or other packetized communication. For instance, communication interface 202 may include a chipset and antenna arranged for wireless communication with a radio access network or an access point. Also, communication interface 202 may take the form of or include a wireline interface, such as an Ethernet, Universal Serial Bus (USB), or High-Definition Multimedia Interface (HDMI) port, among other possibilities. Communication interface 202 may also take the form of or include a wireless interface, such as a Wi-Fi, BLUETOOTH®, global positioning system (GPS), or wide-area wireless interface (e.g., WiMAX or 3GPP Long-Term Evolution (LTE)), among other possibilities. However, other forms of physical layer interfaces and other types of standard or proprietary communication protocols may be used over communication interface 202. Furthermore, communication interface 202 may comprise multiple physical communication interfaces (e.g., a Wi-Fi interface, a BLUETOOTH® interface, and a wide-area wireless interface).

User interface 204 may function to allow computing system 200 to interact with a human or non-human user, such as to receive input from a user and to provide output to the user. Thus, user interface 204 may include input components such as a keypad, keyboard, touch-sensitive panel, button(s), computer mouse, trackball, joystick, microphone, and so on. User interface 204 may also include one or more output components such as a display screen, which, for example, may be combined with a touch-sensitive panel. The display screen may be based on CRT, LCD, LED, and/or OLED technologies, or other technologies now known or later developed. User interface 204 may also be configured to generate audible output(s), via a speaker, speaker jack, audio output port, audio output device, earphones, and/or other similar devices.

Processor 206 may comprise one or more general purpose processors—e.g., microprocessors—and/or one or more special purpose processors—e.g., digital signal processors (DSPs), graphics processing units (GPUs), floating point units (FPUs), network processors, application-specific integrated circuits (ASICs), and/or tensor processing units (TPUs). In some instances, special purpose processors may be capable of audio processing as described in the examples provided herein. Data storage 208 may include one or more volatile and/or non-volatile storage components, such as magnetic, optical, flash, or organic storage, and may be integrated in whole or in part with processor 206. Data storage 208 may include removable and/or non-removable components.

Processor 206 may be capable of executing program instructions 218 (e.g., compiled or non-compiled program logic and/or machine code) stored in data storage 208 to carry out the various functions described herein. Therefore, data storage 208 may include a non-transitory computer-readable medium, having stored thereon program instructions that, upon execution by computing system 200, cause computing system 200 to carry out any of the methods, processes, or operations disclosed in this specification and/or the accompanying drawings. The execution of program instructions 218 by processor 206 may result in processor 206 using data 212.

By way of example, program instructions 218 may include an operating system 222 (e.g., an operating system kernel, device driver(s), and/or other modules) and one or more application programs 220 (e.g., camera functions, address book, email, web browsing, social networking, audio-to-text functions, text translation functions, and/or gaming applications) installed on computing system 200. Similarly, data 212 may include operating system data 216 and application data 214. Operating system data 216 may be accessible primarily to operating system 222, and application data 214 may be accessible primarily to one or more of application programs 220. Application data 214 may be arranged in a file system that is visible to or hidden from a user of computing system 200.

Application programs 220 may communicate with operating system 222 through one or more application programming interfaces (APIs). These APIs may facilitate, for instance, application programs 220 reading and/or writing application data 214, transmitting or receiving information via communication interface 202, receiving and/or displaying information on user interface 204, and so on.

In some cases, application programs 220 may be referred to as “apps” for short. Additionally, application programs 220 may be downloadable to computing system 200 through one or more online application stores or application markets. However, application programs can also be installed on computing system 200 in other ways, such as via a web browser or through a physical interface (e.g., a USB port) on computing system 200.

Audio sensors 224 may include one or more microphones and/or one or more vibration sensors configured to receive and/or capture audible utterance(s), noise(s), and/or signal(s). For example, the one or more microphones may be configured to generate audio signals representing vibrations of a gaseous ambient medium. The one or more vibration sensors may be configured to generate inertial signals representing vibrations of, for example, a user's head or another physical medium configured to resonate based on the user's utterances. Software executed by processor 206 may be configured to control, at least in part, audio sensors 224, and/or may be configured to process the signals generated thereby.

### IV. Example Waveform Synthesis System

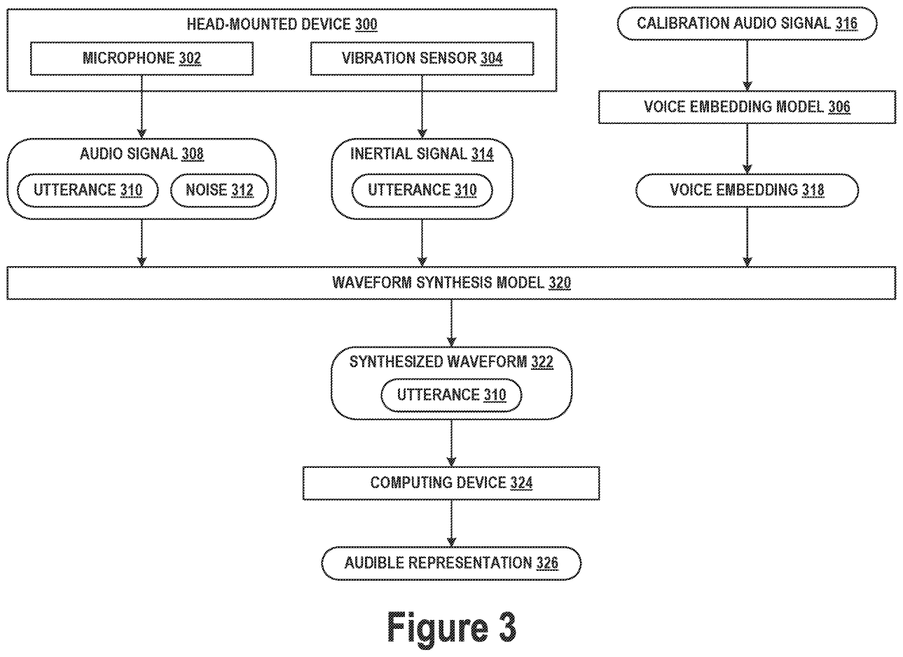

FIG. 3 illustrates an example waveform synthesis system that may include head-mountable device (HMD) 300, voice embedding model 306, and waveform synthesis model 320. The waveform synthesis system may be configured to generate, based on noisy audio waveforms generated by HMD 300, synthesized waveforms that preserve the signal and remove the noise present in the noisy audio waveforms. Thus, the waveform synthesis system may operate as an audio denoising system. The waveform synthesis system may be used to facilitate communications between HMD 300 and computing device 324.

HMD 300 may include microphone 302 and vibration sensor 304. Microphone 302 may be configured to be positioned near a head of a user of HMD 300 (e.g., within several inches of the user's mouth), while vibration sensor 304 may be configured to be positioned in contact with the head. Microphone 302 may be configured to measure vibrations of an ambient medium (e.g., the air surrounding the user), and thus might not be configured to be placed in direct physical contact with the head. Accordingly, microphone 302 may alternatively be referred to as an air conduction audio sensor. Vibration sensor 304 may be configured to measure vibrations of at least part of the head, and thus may be configured to be placed in direct physical contact with the head. Vibration sensor 304 may include an inertial measurement unit (IMU) and one or more components configured to transfer vibrations of the head to the IMU. In one example, vibration sensor 304 may include a bone conduction sensor configured to measure vibrations of one or more bones in the head. Vibration sensor 304 may alternatively be referred to as a voice pick up bone sensor.

Microphone 302 may be configured to generate audio signal 308 and vibration sensor 304 may be configured to generate inertial signal 314. Both audio signal 308 and inertial signal 314 may represent utterance 310 of the user, while audio signal 308 may additionally represent noise 312. Specifically, audio signal 308 may represent vibrations of the ambient medium induced by utterance 310. Inertial signal 314 may represent vibration of the head of the user induced by utterance 310. For example, inertial signal 314 may represent vibrations of the one or more bones that vibration sensor 304 is configured to monitor (e.g., by being placed in indirect physical contact therewith). Thus, audio signal 308 may represent utterance 310 as measured in a predominantly gaseous medium by microphone 302, while inertial signal 314 may represent utterance 310 as measured in a predominantly solid medium by vibration sensor 304.

Utterance 310 may include any vocal sound generated by a user (e.g., a human wearing HMD 300), including, for example, speech and/or musical tones, among other possibilities. Noise 312 may include any vibrations of the ambient medium induced by sources other than utterance 310. Noise 312 may include, for example, sounds generated by machinery, vehicles, collective physical activities of a plurality of other people, and/or collective vocals of a plurality of other people, among other possibilities. Noise 312 may thus alternatively be referred to as ambient noise 312.

Noise 312 may be substantially absent from inertial signal 314, since vibrations of the ambient medium might not induce substantial vibrations at least in the part of the head of the user that is measured by vibration sensor 304. Although under some circumstances noise 312 may be represented by inertial signal 314, the ratio of utterance 310 to noise 312 (i.e., the signal-to-noise ratio) may be sufficiently high that the representation of noise 312 by inertial signal 314 may be ignored for practical purposes. For example, a magnitude of the representation of noise 312 in inertial signal 314 may be smaller than inherent noise of vibration sensor 304. Accordingly, utterance 310, as represented by inertial signal 314, may be substantially uncorrupted by noise 312.

Voice embedding model 306 may be configured to generate voice embedding 318 based on calibration audio signal 316. Calibration audio signal 316 may be generated by microphone 302 and may represent vibrations of the ambient medium induced by one or more calibration utterances. For example, prior to the waveform synthesis system being used to denoise audio signal 308, the user may be asked to speak a series of words in an environment that is substantially noise free (e.g., an environment where the signal-to-noise ratio of the resulting calibration audio signal is above a threshold signal-to-noise ratio). Thus, calibration audio signal 316 may represent samples of the user's voice that include no more than a threshold amount of ambient noise, and thus provide a baseline/reference of how the user's voice sounds.

Voice embedding 318 may include a tensor (e.g., vector or matrix) that includes a plurality of values that provide a numerical representation of characteristics of the user's voice. Voice embedding 318 may thus provide information about (i) how to distinguish utterance 310 from noise 312 in audio signal 308 and/or (ii) how to generate synthesized waveform 322 to sound like the user that spoke utterance 310.

Voice embedding model 306 may include a machine learning (ML) model configured to generate voice embeddings for a plurality of different users. The ML model may include, for example, an artificial neural network. For example, voice embedding model 306 may be configured to map voices to a vector space such that, for example, similar voices are closer together in the vector space than dissimilar voices. Voice embedding model 306 may be pretrained using a plurality of different voice samples of the plurality of different users, and may be usable with respect to users that were not explicitly represented as part of the training data.

Waveform synthesis model 320 may be configured to generate synthesized waveform 322 based on audio signal 308, inertial signal 314, and voice embedding 318. Specifically, audio signal 308 may represent a corrupted version of a signal that waveform synthesis model 320 is tasked with denoising, and inertial signal 314 and voice embedding 318 may provide additional information on how to achieve such denoising by synthesizing a new waveform. Inertial signal 314 may provide a substantially noise-free representation of the signal measured in a different manner than audio signal 308, and voice embedding 318 may represent characteristics of the voice in which utterance 310 was generated and/or is to be reconstructed.

Accordingly, synthesized waveform 322 may represent utterance 310 in the voice of the user of HMD 300 and independently of noise 312. Synthesized waveform 322 may span a same time period as audio signal 308 and inertial signal 314. Thus, synthesized waveform 322 may approximate audio signal 308 with noise 312 removed therefrom.

In some implementations, waveform synthesis model 320 may implement a waveform-to-waveform mapping between (i) audio signal 308 and inertial signal 314 and (ii) synthesized waveform 322. For example, waveform synthesis model 320 may be configured to generate synthesized waveform 322 without generating an intermediate non-numerical representation (e.g., an intermediate textual representation) of utterance 310. Although waveform synthesis model 320 may be configured to generate one or more numerical latent representation of utterance 310, these numerical latent representations might not be human-interpretable. Accordingly, waveform synthesis model 320 may be configured to preserve a prosody and/or other audible properties of utterance 310, resulting in synthesized waveform 322 that accurately and/or naturally representing utterance 310 in the voice of the user.

Waveform synthesis model 320 may include one or more ML models. For example, waveform synthesis model 320 may include an artificial neural network, which may be structured according to a plurality of possible architectures, including architectures based on, for example, convolutions, transformers, autoencoders, diffusion models, and/or generative adversarial networks (GANs), among other possibilities.

Synthesized waveform 322 may be provided by the waveform synthesis system to computing device 324 as part of, for example, a voice communication session. Computing device 324 may be configured to generate audible representation 326 of synthesized waveform 322 using one or more speakers thereof. Since synthesized waveform 322 does not represent noise 312, audible representation 326 may represent utterance 310 approximately and/or substantially as it was originally made by the user and undegraded by noise 312. Accordingly, the waveform synthesis system may allow HMD 300 to be used for voice communications in noisy environments (e.g., construction sites, sports events, concerts, etc.). For example, HMD 300 may be used in a noisy environment to perform an audio call with computing device 324, and a listener at computing device 324 may hear the user of HMD 300 but might not hear the noisy environment.

In one example, waveform synthesis model 320 and/or voice embedding model 306 may be stored on and/or executed by HMD 300. For example, HMD 300 may include at least some of the components of computing system 200, and may implement waveform synthesis model 320 and/or voice embedding model 306 using hardware and/or software. Accordingly, HMD 300 may be configured to transmit synthesized waveform 322 to computing device 324 (e.g., over a network, or over a direct local connection) to allow for voice communications between HMD 300 and computing device 324.

In another example, waveform synthesis model 320 and/or voice embedding model 306 may be stored on and/or executed by an additional computing device (not shown) communicatively connected to HMD 300 and computing device 324. For example, the additional computing device may be a personal computing device of the user (e.g., phone) located in proximity of the user, and/or a server device by way of which communications are transmitted between HMD 300 and computing device 324. Accordingly, the additional computing device may be configured to receive, from HMD 300, audio signal 308 and inertial signal 314, generate synthesized waveform 322, and transmit synthesized waveform 322 to computing device 324 to facilitate voice communications between HMD 300 and computing device 324.

In some cases, utterance 310 may be generated by a user whose voice is temporarily or permanently damaged (e.g., due to an illness and/or physical injury). Calibration audio signal 316 may be captured prior to occurrence of the voice damage, and voice embedding 318 may thus represent the user's voice in an undamaged state. Accordingly, waveform synthesis model 320 may additionally or alternatively be used to compensate for the damage to the user's voice. For example, waveform synthesis model 320 may be configured to generate synthesized waveform 322 to represent utterance 310 as it would sound if the user's voice was not damaged. Stated another way, properties of audio signal 308 attributable to the voice damage may be considered to be part of noise 312, and thus might not be present as part of synthesized waveform 322, resulting in synthesized waveform 322 representing an enhancement of utterance 310 as originally represented in audio signal 308.

In some implementations, HMD 300 may instead be used in combination with a text synthesis model to generate text that represents utterance 310. For example, the text synthesis model may be used when utterance 310 is intended for a computing device rather than a human user. For example, utterance 310 may be intended to provide instructions to a robotic device, rather than to communicate with another human user. Thus, audio signal 308 and inertial signal 314 may be used by the text synthesis model to generate text that represents utterance 310 independently of noise 312. The text may be provided as input to a computing device (e.g., personal computing device, robotic device, vehicle, etc.) to cause the computing device to perform one or more operations based on the text. In some cases, waveform synthesis model 320 and the text synthesis model may be used in combination, with waveform synthesis model 320 facilitating a voice communication between users and the text synthesis model generating a transcript of the voice communication.

In some implementations, the text synthesis model may operate without utilizing voice embedding 318, since the textual output of the text synthesis model may be voice-independent. In other implementations, the text synthesis model may utilize voice embedding 318 to assist with disentangling representations of utterance 310 and noise 312 in audio signal 308. That is, since voice embedding 318 provides information about how the user's utterances sound, it may allow the text synthesis model to more accurately distinguish utterances from noise.

### V. Example Waveform-to-Waveform Mapping

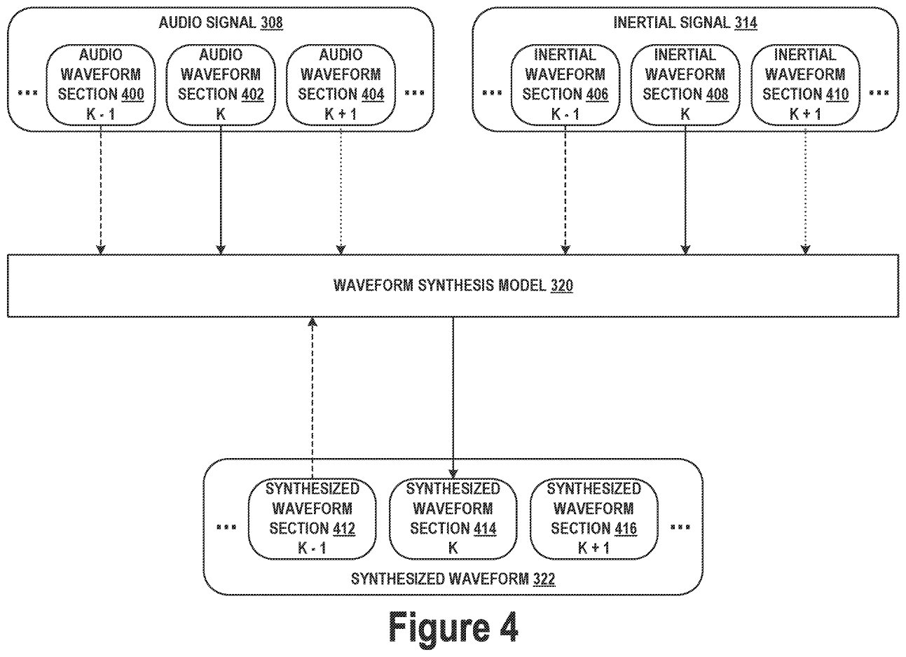

FIG. 4 illustrates an example waveform-to-waveform mapping that may be implemented by waveform synthesis model 320. Each of audio signal 308, inertial signal 314, and synthesized waveform 322 may include a corresponding plurality of waveform sections, each of which may include one or more waveform samples. Waveform synthesis model 320 may be configured to generate synthesized waveform 322 in incremental sections as corresponding portions of audio signal 308 and inertial signal 314 become available. Such incremental generation of portions of synthesized waveform 322 may allow utterances to be denoised and streamed as part of, for example, a live voice communication.

Audio signal 308 may include a plurality of audio waveform sections, including audio waveform section 400 corresponding to time period K−1, audio waveform section 402 corresponding to time period K, and audio waveform section 404 corresponding to time period K+1. Inertial signal 314 may include a plurality of inertial waveform sections, including inertial waveform section 406 corresponding to time period K−1, inertial waveform section 408 corresponding to time period K, and inertial waveform section 410 corresponding to time period K+1. Synthesized waveform 322 may include a plurality of synthesized waveform sections, including synthesized waveform section 412 corresponding to time period K−1, synthesized waveform section 414 corresponding to time period K, and synthesized waveform section 416 corresponding to time period K+1.

Time periods K−1, K, and K+1 are provided as illustrative examples of a plurality of time periods spanned by audio signal 308, inertial signal 314, and synthesized waveform 322. The plurality of time periods may include other time periods (e.g., K−3, K−2, K+2, K+3, etc.), as indicated by the ellipses. Each of time periods K−1, K, and K+1 may include one or more samples associated with corresponding time points. For example, each time period may include a plurality of samples spanning a time period of 1 millisecond. In some cases, a number of samples per time period may be the same for each of audio signal 308, inertial signal 314, and synthesized waveform 322. In other cases, the number of samples per time period may differ across audio signal 308, inertial signal 314, and/or synthesized waveform 322.

Waveform synthesis model 320 may be configured to generate synthesized waveform section 414 based at least on audio waveform section 402 and inertial waveform section 408. That is, the portion of synthesized waveform 322 corresponding to time period K may be based on the samples of temporally corresponding (i.e., corresponding to time period K) portions of audio signal 308 and inertial signal 314.

In some implementations, waveform synthesis model 320 may be configured to generate synthesized waveform section 414 based additionally on audio samples and/or inertial samples from a preceding time period. Specifically, waveform synthesis model 320 may be configured to generate synthesized waveform section 414 based additionally on one or more audio samples of audio waveform section 400 and/or one or more inertial samples of inertial waveform section 406. That is, the portion of synthesized waveform 322 corresponding to time period K may be additionally based on the samples of temporally preceding (i.e., corresponding to time periods K−1, K−2, K−3, etc.) portions of audio signal 308 and/or inertial signal 314.

In some implementations, waveform synthesis model 320 may be configured to generate synthesized waveform section 414 based additionally on audio samples and/or inertial samples from a successive time period. Specifically, waveform synthesis model 320 may be configured to generate synthesized waveform section 414 based additionally on one or more audio samples of audio waveform section 404 and/or one or more inertial samples of inertial waveform section 410. That is, the portion of synthesized waveform 322 corresponding to time period K may be additionally based on the samples of temporally successive (i.e., corresponding to time periods K+1, K+2, K+3, etc.) portions of audio signal 308 and/or inertial signal 314.

Considering preceding and/or successive samples in this manner may improve an aural quality of synthesized waveform 322. Specifically, by looking back at preceding samples and/or by looking ahead to successive samples, waveform synthesis model 320 may generate synthesized waveform section 414 such that it includes fewer artifacts and/or inconsistencies (e.g., at section boundaries) that could degrade a signal quality thereof. Considering successive samples may also introduce a delay into the generation of synthesized waveform 322. That is, synthesized waveform section 414 might not be generated until generation of a last successive sample on which synthesized waveform section 414 depends, thus adding a delay based on a number of successive time periods considered by waveform synthesis model 320. Thus, a number of successive samples considered by waveform synthesis model 320 in generating a given synthesized waveform section may be based on a maximum tolerable latency of the waveform synthesis system.

In some implementations, waveform synthesis model 320 may be configured to generate synthesized waveform section 414 recursively by additionally considering synthesized samples from a preceding time period. Specifically, waveform synthesis model 320 may be configured to generate synthesized waveform section 414 based additionally on one or more audio samples of synthesized waveform section 412. That is, the portion of synthesized waveform 322 corresponding to time period K may be additionally based on the samples of temporally preceding (i.e., corresponding to time periods K−1, K−2, K−3, etc.) portions of synthesized waveform 322. By operating recursively, waveform synthesis model 320 may be able to reduce a number and/or intensity of artifacts and/or inconsistencies (e.g., at section boundaries) in synthesized waveform 322 that could degrade a signal quality thereof. For example, synthesized waveform 322 may be smoother and/or include fewer discontinuities, and may thus exhibit a higher aural quality.

### VI. Example Training System

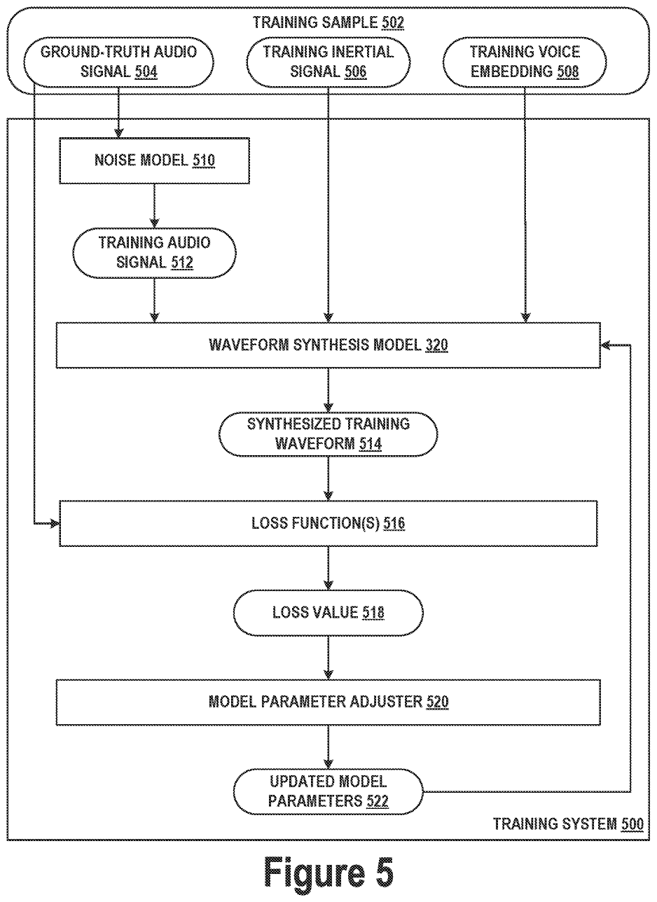

FIG. 5 illustrates training system 500 configured to train one or more trainable components of waveform synthesis model 320 based on a plurality of training samples, of which training sample 502 is provided as a representative example. Specifically, training system 500 may be configured to train waveform synthesis model 320 to generate synthesized waveforms that represent denoised versions of corresponding audio signals. Training system 500 may include noise model 510, loss function(s) 516, and model parameter adjuster 520.

Training sample 502 may include ground-truth audio signal 504, training inertial signal 506, and training voice embedding 508. Ground-truth audio signal 504 may represent one or more training utterances of a training user, and may be generated using one or more microphones (e.g., microphone 302). Ground-truth audio signal 504 may be captured in a substantially noise-free environment, and may thus represent a synthesis target for waveform synthesis model 320. Training inertial signal 506 may represent the one or more training utterances of the training user, and may be generated using one or more vibration sensors (e.g., vibration sensor 304). Accordingly, training inertial signal 506 may be analogous to inertial signal 314, but may be processed at training time rather than at inference time. Training voice embedding 508 may represent a voice of the training user. Accordingly, training voice embedding 508 may be analogous to voice embedding 318, but may be processed at training time rather than at inference time.

Noise model 510 may be configured to generate training audio signal 512 based on ground-truth audio signal 504. Specifically, noise model 510 may be configured to add, to ground-truth audio signal 504, noise that waveform synthesis model 320 is to be trained to remove as it generates synthesized waveforms. Thus, noise model 510 may be configured to add, for example, various types of ambient noise expected to be encountered by the user of HMD 300 in various environments. At least some of the noise added by noise model 510 may be representative of noise 312. Accordingly, training audio signal 512 may be analogous to audio signal 308, but may be processed at training time rather than at inference time.

Waveform synthesis model 320 may be configured to generate synthesized training waveform 514 based on training audio signal 512, training inertial signal 506, and training voice embedding 508. Synthesized training waveform 514 may be analogous to synthesized waveform 322, but may be determined at training time rather than at inference time. Synthesized training waveform 514 may represent an attempt by waveform synthesis model 320 at generation of ground-truth audio signal 504, which represents a denoised version of training audio signal 512. Over the course of training, the extent to which synthesized training waveform 514 matches ground-truth audio signal 504 may increase.

Loss function(s) 516 may be configured to generate loss value 518 based at least on ground-truth audio signal 504 and synthesized training waveform 514. For example, loss function(s) 516 may be configured to determine (i) a difference (e.g., mean squared error (MSE) and/or mean absolute error (MAE)) between ground-truth audio signal 504 and synthesized training waveform 514, (ii) a difference between a spectrogram of ground-truth audio signal 504 and a spectrogram of synthesized training waveform 514, and/or (iii) a difference between perceptual features of ground-truth audio signal 504 and perceptual features of synthesized training waveform 514, among other possibilities. Thus, loss function(s) 608 may be configured to incentivize waveform synthesis model 320 to generate synthesized training waveform 514 that matches ground-truth audio signal 504.

Model parameter adjuster 520 may be configured to determine updated model parameters 522 based on loss value 518. Specifically, updated model parameters 522 may be selected such that, during a subsequent iteration of processing of training sample 502, synthesized training waveform 514 more closely matches ground-truth audio signal 504. Updated model parameters 522 may include one or more updated parameters of any trainable component of waveform synthesis model 320.

Model parameter adjuster 520 may be configured to determine updated model parameters 522 by, for example, determining a gradient of loss function(s) 516. Based on this gradient and loss value 518, model parameter adjuster 520 may be configured to select updated model parameters 522 that are expected to reduce loss value 518, and thus improve a performance of waveform synthesis model 320. After applying updated model parameters 522 to waveform synthesis model 320, the operations discussed above may be repeated to compute another instance of loss value 518 and, based thereon, another instance of updated model parameters 522 may be determined and applied to waveform synthesis model 320 to further improve the performance thereof. Such training of waveform synthesis model 320 may be repeated until, for example, loss value 518 is reduced to below a target loss value.

In some implementations, training system 500 may be configured to train an HMD-specific instance of waveform synthesis model 320. For example, the plurality of training samples used by training system 500 may be obtained from an HMD that, when worn by the user, places the microphone thereof within a first range of poses relative to the head of the user and places the vibration sensor within a second range of poses relative to the head of the user. For example, the plurality of training samples may be obtained from a particular HMD model (of which multiple instances may be available for use), and the HMD-specific instance of waveform synthesis model 320 may thus be specific to the particular HMD model.

Placement of the microphone outside of the first range of poses and/or placement of the vibration sensor outside of the second range of poses may affect how users' utterances are represented in signals generated by these sensors. For example, a user's utterances may vibrate different bones in the user's head with differing amplitudes and/or frequencies due to differences in the bones' physical properties (e.g., size, position, density, etc.). Thus, a first instance of waveform synthesis model 320 trained using training data obtained from a first HMD model might not perform as well with respect to inference data obtained from a second HMD model (having different sensor placement) as a second instance of waveform synthesis model 320 trained using training data obtained from the second HMD model. Accordingly, training system 500 may be configured to train a plurality of instances of waveform synthesis model 320. Each respective instance of the plurality of instances of waveform synthesis model 320 may (i) correspond to a particular HMD model with a corresponding spatial placement of the microphone and vibration sensor relative to the head of the user and (ii) be trained using training data generated by the corresponding HMD model.

### VII. Additional Example Operations

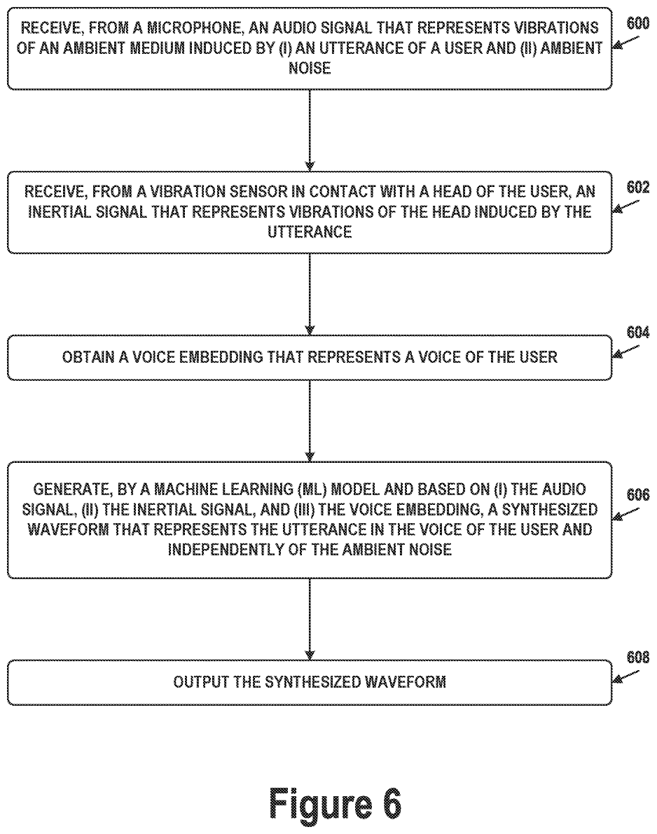

FIG. 6 illustrates a flow chart of operations related to generating an output audio waveform that reconstructs an input audio waveform to be substantially free of noise present in the input audio waveform. The operations may be carried out by HMD 100, computing system 200, the waveform synthesis system of FIG. 3, and/or training system 500, among other possibilities. The embodiments of FIG. 6 may be simplified by the removal of any one or more of the features shown therein. Further, these embodiments may be combined with features, aspects, and/or implementations of any of the previous figures or otherwise described herein.

Block 600 may involve receiving, from a microphone, an audio signal that represents vibrations of an ambient medium induced by (i) an utterance of a user and (ii) ambient noise.

Block 602 may involve receiving, from a vibration sensor in contact with a head of the user, an inertial signal that represents vibrations of the head induced by the utterance.

Block 604 may involve obtaining a voice embedding that represents a voice of the user.

Block 606 may involve generating, by an ML model and based on (i) the audio signal, (ii) the inertial signal, and (iii) the voice embedding, a synthesized waveform that represents the utterance in the voice of the user and independently of the ambient noise.

Block 608 may involve outputting the synthesized waveform.

In some examples, the ML model may be configured to preserve a prosody of the utterance in generating the synthesized waveform by implementing a waveform-to-waveform mapping.

In some examples, the microphone may be configured to be placed within a first range of poses relative to the head of the user. The vibration sensor may be configured to be placed within a second range of poses relative to the head of the user. The ML model may be configured to generate synthesized waveforms based on audio signals generated by microphones placed within the first range of poses and inertial signals generated by vibration sensors placed within the second range of poses.

In some examples, generating the synthesized waveform may include generating a plurality of synthesized waveform sections that form the synthesized waveform. Each respective synthesized waveform section of the plurality of synthesized waveform sections may include at least one synthesized sample that is associated with a corresponding time point of a plurality of time points of the synthesized waveform.

In some examples, the ML model may be configured to generate each respective synthesized waveform section of the plurality of synthesized waveform sections based on at least one synthesized waveform section generated by the ML model and that temporally precedes the respective synthesized waveform section within the synthesized waveform.

In some examples, the ML model may be configured to generate each respective synthesized waveform section of the plurality of synthesized waveform sections based on (i) at least one preceding audio sample of the audio signal and (ii) at least one preceding inertial sample of the inertial signal. Each of the at least one preceding audio sample and the at least one preceding inertial sample may correspond to at least one time point that precedes all time points of the respective synthesized waveform section.

In some examples, the ML model may be configured to generate each respective synthesized waveform section of the plurality of synthesized waveform sections based on (i) at least one successive audio sample of the audio signal and (ii) at least one successive inertial sample of the inertial signal. Each of the at least one successive audio sample and the at least one successive inertial sample may correspond to at least one time point that follows all time points of the respective synthesized waveform section.

In some examples, generating the synthesized waveform may include generating the synthesized waveform by the ML model without generating an intermediate textual representation of the utterance.

In some examples, each of the microphone and the vibration sensor may form part of a head-mountable device configured to be worn on the head of the user.

In some examples, the head-mountable device may include one or more of: headphones, eyeglasses, googles, or a headset.

In some examples, the vibration sensor may include a bone conduction sensor configured to be placed within a threshold distance of at least one bone in the head of the user. The inertial signal may represent vibrations of the at least one bone induced by the utterance.

In some examples, obtaining the voice embedding may include, prior to receiving the audio signal and the inertial signal, receiving, from one or more microphones, a calibration audio signal that represents vibrations of the ambient medium induced by a calibration utterance of the user generated in an environment with no more than a threshold amount of ambient noise. The voice embedding may be generated by processing the calibration audio signal by a voice embedding model that has been trained to generate voice embeddings for a plurality of different users.

In some examples, the voice embedding may include a tensor representing properties of the voice of the user using a plurality of values.

In some examples, outputting the synthesized waveform may include generating an audible representation of the synthesized waveform.

In some examples, the microphone and the vibration sensor may be connected to a first computing device. Outputting the synthesized waveform may include transmitting the synthesized waveform from the first computing device to a second computing device. The audible representation of the synthesized waveform may be generated by the second computing device.

In some examples, the ML model may be configured to generate synthesized waveforms that include one or more artifacts of one or more lossy audio compression algorithms used as part of transmitting the synthesized waveform from the first computing device to a second computing device.

In some examples, the ML model may be trained using a training process that includes determining a ground-truth audio signal generated using one or more microphones and representing vibrations of the ambient medium induced by a training utterance of a training user. The training process may also include determining a training inertial signal generated using one or more vibration sensors in contact with a head of the training user and representing vibrations of the head of the training user induced by the training utterance. The training process may additionally include obtaining a training voice embedding that represents a voice of the training user. The training process may further include generating a training audio signal by adding noise to the ground-truth audio signal. The training process may yet additionally include generating, by the ML model and based on (i) the training audio signal, (ii) the training inertial signal, and (iii) the training voice embedding, a synthesized training waveform. The training process may yet further include determining a loss value based on the synthesized training waveform and the ground-truth audio signal, and updating one or more parameters of the ML model based on the loss value.

In some examples, determining the ground-truth audio signal may include obtaining a non-degraded ground-truth audio signal generated using the one or more microphones and representing vibrations of the ambient medium induced by the training utterance of a training user, and generating the ground-truth audio signal by compressing and subsequently decompressing the non-degraded ground-truth audio signal using a lossy audio compression algorithm. The ML model may be configured to generate synthesized waveforms that include one or more artifacts of the lossy audio compression algorithm.

### VIII. Conclusion

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical operations or actions in the method or technique. The program code and/or related data may be stored on any type of computer readable medium such as a storage device including random access memory (RAM), a disk drive, a solid state drive, or another storage medium.

The computer readable medium may also include non-transitory computer readable media such as computer readable media that store data for short periods of time like register memory, processor cache, and RAM. The computer readable media may also include non-transitory computer readable media that store program code and/or data for longer periods of time. Thus, the computer readable media may include secondary or persistent long term storage, like read only memory (ROM), optical or magnetic disks, solid state drives, compact-disc read only memory (CD-ROM), for example. The computer readable media may also be any other volatile or non-volatile storage systems. A computer readable medium may be considered a computer readable storage medium, for example, or a tangible storage device.

Moreover, a step or block that represents one or more information transmissions may correspond to information transmissions between software and/or hardware modules in the same physical device. However, other information transmissions may be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

1. A computer-implemented method comprising:
receiving, from a microphone, an audio signal that represents vibrations of an ambient medium induced by (i) an utterance of a user and (ii) ambient noise;
receiving, from a vibration sensor in contact with a head of the user, an inertial signal that represents vibrations of the head induced by the utterance;
obtaining a voice embedding that represents a voice of the user;
generating, by a machine learning (ML) model and based on (i) the audio signal, (ii) the inertial signal, and (iii) the voice embedding, a synthesized waveform that represents the utterance in the voice of the user and independently of the ambient noise; and
outputting the synthesized waveform.

2. The computer-implemented method of claim 1, wherein the ML model is configured to preserve a prosody of the utterance in generating the synthesized waveform by implementing a waveform-to-waveform mapping.

3. The computer-implemented method of claim 1, wherein the microphone is configured to be placed within a first range of poses relative to the head of the user, wherein the vibration sensor is configured to be placed within a second range of poses relative to the head of the user, and wherein the ML model is configured to generate synthesized waveforms based on audio signals generated by microphones placed within the first range of poses and inertial signals generated by vibration sensors placed within the second range of poses.

4. The computer-implemented method of claim 1, wherein generating the synthesized waveform comprises:
generating a plurality of synthesized waveform sections that form the synthesized waveform, wherein each respective synthesized waveform section of the plurality of synthesized waveform sections comprises at least one synthesized sample that is associated with a corresponding time point of a plurality of time points of the synthesized waveform.

5. The computer-implemented method of claim 4, wherein the ML model is configured to generate each respective synthesized waveform section of the plurality of synthesized waveform sections based on at least one synthesized waveform section generated by the ML model and that temporally precedes the respective synthesized waveform section within the synthesized waveform.

6. The computer-implemented method of claim 4, wherein the ML model is configured to generate each respective synthesized waveform section of the plurality of synthesized waveform sections based on (i) at least one preceding audio sample of the audio signal and (ii) at least one preceding inertial sample of the inertial signal, wherein each of the at least one preceding audio sample and the at least one preceding inertial sample corresponds to at least one time point that precedes all time points of the respective synthesized waveform section.

7. The computer-implemented method of claim 4, wherein the ML model is configured to generate each respective synthesized waveform section of the plurality of synthesized waveform sections based on (i) at least one successive audio sample of the audio signal and (ii) at least one successive inertial sample of the inertial signal, wherein each of the at least one successive audio sample and the at least one successive inertial sample corresponds to at least one time point that follows all time points of the respective synthesized waveform section.

8. The computer-implemented method of claim 1, wherein generating the synthesized waveform comprises:
generating the synthesized waveform by the ML model without generating an intermediate textual representation of the utterance.

9. The computer-implemented method of claim 1, wherein each of the microphone and the vibration sensor forms part of a head-mountable device configured to be worn on the head of the user.

10. The computer-implemented method of claim 9, wherein the head-mountable device comprises one or more of: headphones, eyeglasses, googles, or a headset.

11. The computer-implemented method of claim 1, wherein the vibration sensor comprises a bone conduction sensor configured to be placed within a threshold distance of at least one bone in the head of the user, and wherein the inertial signal represents vibrations of the at least one bone induced by the utterance.

12. The computer-implemented method of claim 1, wherein obtaining the voice embedding comprises:
prior to receiving the audio signal and the inertial signal, receiving, from one or more microphones, a calibration audio signal that represents vibrations of the ambient medium induced by a calibration utterance of the user generated in an environment with no more than a threshold amount of ambient noise; and
generating the voice embedding by processing the calibration audio signal by a voice embedding model that has been trained to generate voice embeddings for a plurality of different users.

13. The computer-implemented method of claim 1, wherein the voice embedding comprises a tensor representing properties of the voice of the user using a plurality of values.

14. The computer-implemented method of claim 1, wherein outputting the synthesized waveform comprises:
generating an audible representation of the synthesized waveform.

15. The computer-implemented method of claim 1, wherein the microphone and the vibration sensor are connected to a first computing device, and wherein outputting the synthesized waveform comprises:
transmitting the synthesized waveform from the first computing device to a second computing device, wherein an audible representation of the synthesized waveform is generated by the second computing device.

16. The computer-implemented method of claim 15, wherein the ML model is configured to generate synthesized waveforms that include one or more artifacts of one or more lossy audio compression algorithms used as part of transmitting the synthesized waveform from the first computing device to a second computing device.

17. The computer-implemented method of claim 1, wherein the ML model is trained using a training process comprising:
determining a ground-truth audio signal generated using one or more microphones and representing vibrations of the ambient medium induced by a training utterance of a training user;
determining a training inertial signal generated using one or more vibration sensors in contact with a head of the training user and representing vibrations of the head of the training user induced by the training utterance;
obtaining a training voice embedding that represents a voice of the training user;
generating a training audio signal by adding noise to the ground-truth audio signal;
generating, by the ML model and based on (i) the training audio signal, (ii) the training inertial signal, and (iii) the training voice embedding, a synthesized training waveform;
determining a loss value based on the synthesized training waveform and the ground-truth audio signal; and
updating one or more parameters of the ML model based on the loss value.

18. The computer-implemented method of claim 17, wherein determining the ground-truth audio signal comprises:
obtaining a non-degraded ground-truth audio signal generated using the one or more microphones and representing vibrations of the ambient medium induced by the training utterance of a training user; and
generating the ground-truth audio signal by compressing and subsequently decompressing the non-degraded ground-truth audio signal using a lossy audio compression algorithm, wherein the ML model is configured to generate synthesized waveforms that include one or more artifacts of the lossy audio compression algorithm.

19. A system comprising:
a processor; and
a non-transitory computer-readable medium having stored thereon instructions that, when executed by the processor, cause the processor to perform operations comprising:
receiving, from a microphone, an audio signal that represents vibrations of an ambient medium induced by (i) an utterance of a user and (ii) ambient noise;
receiving, from a vibration sensor in contact with a head of the user, an inertial signal that represents vibrations of the head induced by the utterance;
obtaining a voice embedding that represents a voice of the user;
generating, by a machine learning (ML) model and based on (i) the audio signal, (ii) the inertial signal, and (iii) the voice embedding, a synthesized waveform that represents the utterance in the voice of the user and independently of the ambient noise; and
outputting the synthesized waveform.

20. A non-transitory computer-readable medium having stored thereon instructions that, when executed by a computing device, cause the computing device to perform operations comprising:
receiving, from a microphone, an audio signal that represents vibrations of an ambient medium induced by (i) an utterance of a user and (ii) ambient noise;
receiving, from a vibration sensor in contact with a head of the user, an inertial signal that represents vibrations of the head induced by the utterance;
obtaining a voice embedding that represents a voice of the user;
generating, by a machine learning (ML) model and based on (i) the audio signal, (ii) the inertial signal, and (iii) the voice embedding, a synthesized waveform that represents the utterance in the voice of the user and independently of the ambient noise; and
outputting the synthesized waveform.
